(19) United States
(12) Patent Application Publication
(10) Pub. No.: US 2009/0223191 A1
(43) Pub. Date: Sep. 10, 2009

(54) Mechanical Interlock for a Control Member

(76) Inventor: Grant Thomas Wilson, Neenah, WI (US)

Correspondence Address: QUARLES & BRADY LLP, 411 E. WISCONSIN AVENUE, SUITE 2040, MILWAUKEE, WI, 53202-4497, US

(21) Appl. No.: 12/045,469

(22) Filed: Mar. 10, 2008

(51) Int. Cl. G05G 1/04; A01D 69/00

(52) U.S. Cl. 56/11.7; 74/491

(57) ABSTRACT

The mechanical interlock prevents inadvertent engagement of a control member. Rotation of the mechanical interlock about an interlock axis from a locked position to an engagement position allows the control member to rotate about a control axis. The mechanical interlock includes an interlock bracket that defines a guide path having locking and actuating segments that intersect at an acute angle, and a guide member that engages the guide path. One of the interlock bracket or the guide member is pivotally coupled to the control member about the interlock axis and the other is coupled to a handle. The guide path and the guide member are selectively positionable between a locked position where the guide member is proximate the locking segment, an engaged position where the guide member is proximate the intersection, and an actuated position where the guide member is proximate the actuating segment.

### CROSS REFERENCES TO RELATED APPLICATIONS

Not Applicable

### STATEMENT REGARDING FEDERALLY SPONSORED RESEARCH

Not Applicable.

### BACKGROUND OF THE INVENTION

The present invention relates to an interlock for a control member, and more particularly to a mechanical interlock allowing selective actuation of an implement control member.

A variety of implements, such as lawnmowers, snow-throwers, string trimmers, augers, blowers, and the like, incorporate some type of control member (e.g., paddle, lever, bar, trigger, etc.) to actuate the working device of the implement. For example, a snow-thrower may include a pair of control paddles, one to activate the horizontal auger and vertical impeller to direct snow, and the other to activate the drive wheels to propel the snow-thrower in the desired direction.

Several systems and devices have been developed to reduce the frequency and ease with which the control member of an implement can be unintentionally actuated. Many of the current developments use electrical components to monitor the position of the control member and/or a secondary safety member in an attempt to ensure that the operator intends to activate the implement.

Electronic interlock systems suffer from several drawbacks. For instance, environmental contaminants (e.g., dirt, dust, water, etc.) can degrade or prevent the consistent operation of the electrical interlock system. Additionally, use of electrical contacts, position sensors, wire harnesses, and the like, may be both expensive and unnecessarily complex.

Many of the electrically based systems also incorporate an assortment of mechanical components. Mechanical designs often present additional drawbacks, such as requiring alignment or adjustment by a skilled technician in order to ensure proper operation of the interlock and control member. Moreover, many of the current mechanical interlocks are difficult to operate as they require the operator to perform a series of steps or are not ergonomically engaged.

Therefore, a need exists for a mechanical interlock for a control member that is robust, efficient to manufacture, easy to install and maintain, and reduces inadvertent actuation of the associated control member.

### SUMMARY OF THE INVENTION

The present invention generally provides a mechanical interlock reducing inadvertent engagement of a control member. In one aspect, the present invention provides an implement including a handle extending from the implement and a control member pivotally coupled to the handle about a control axis. A mechanical interlock includes an interlock bracket that is pivotally coupled to the control member about an interlock axis. A guide path is formed in the interlock bracket and has a locking segment and an actuating segment that intersect at an acute angle. And, a guide member is coupled to the handle and configured to engage the guide path. The mechanical interlock is positionable at a locked position where the guide member is proximate the locking segment, an engaged position where the guide member is proximate the intersection of the locking segment and the actuating segment, and an actuated position where the guide member is proximate the actuating segment. The control member is prevented from pivoting about the control axis when the mechanical interlock is in the locked position.

In another aspect, the present invention provides a mechanical interlock that is coupleable to a control member pivotally coupled to a handle about a control axis. The mechanical interlock includes an interlock bracket that defines a guide path having a locking segment and an actuating segment that form an intersection at an acute angle. A guide member is configured to engage the guide path. One of the interlock bracket or the guide member is pivotally coupled to the control member about an interlock axis and the other is coupled to the handle. The guide path and the guide member are selectively positionable between a locked position where the guide member is proximate the locking segment, an engaged position where the guide member is proximate the intersection, and an actuated position where the guide member is proximate the actuating segment. The control member is prevented from pivoting about the control axis when the guide path and the guide member are positioned at the locked position.

In yet a further aspect, the invention provides a method of activating a control member that is pivotally coupled to a control handle about a control axis and that incorporates a mechanical interlock. The method includes the steps of providing an interlock bracket defining a guide path having a locking segment and an actuating segment that form an intersection at an acute angle, and providing a guide member configured to selectively engage the guide path. Then, pivoting one of the interlock bracket or the guide member about an interlock axis from a locked position at which the guide member is proximate the locking segment to an engaged position at which the guide member is proximate the intersection, and pivoting the control member about the control axis to move the interlock bracket and the guide member from the engaged position to an actuated position at which the guide member is proximate the actuating segment.

These and still other aspects of the present invention will be apparent from the description that follows. In the detailed description, a preferred example embodiment of the invention will be described with reference to the accompanying drawings. This embodiment does not represent the full scope of the invention; rather the invention may be employed in other embodiments. Reference should therefore be made to the claims herein for interpreting the breadth of the invention.

### BRIEF DESCRIPTION OF THE DRAWINGS

FIG. 1 is a perspective view of an implement incorporating a mechanical interlock in accordance with the present invention;

FIG. 2 is a perspective view of the mechanical interlock;

FIG. 3 is an isometric exploded view of the mechanical interlock;

FIG. 4A is a side elevation view of the mechanical interlock in the locked position;

FIG. 4B is a side elevation view of the mechanical interlock in the engaged position; and

FIG. 4C is a side elevation view of the mechanical interlock in the actuated position.

### DETAILED DESCRIPTION OF THE PREFERRED EXAMPLE EMBODIMENT

The preferred example embodiment of the mechanical interlock will be described in relation to a lawnmower having a control paddle; however, the present invention is equally applicable to other types and styles of implements (such as snow-throwers, string trimmers, augers, blowers, and the like) having a variety of control members (such as levers, bars, triggers, and the like). Additionally, while the example embodiment will describe a mechanical interlock that selectively locks the control member in the deactivated position, the invention contemplates a mechanical interlock adapted to selectively lock a control member in the activated position or any desired intermediate position.

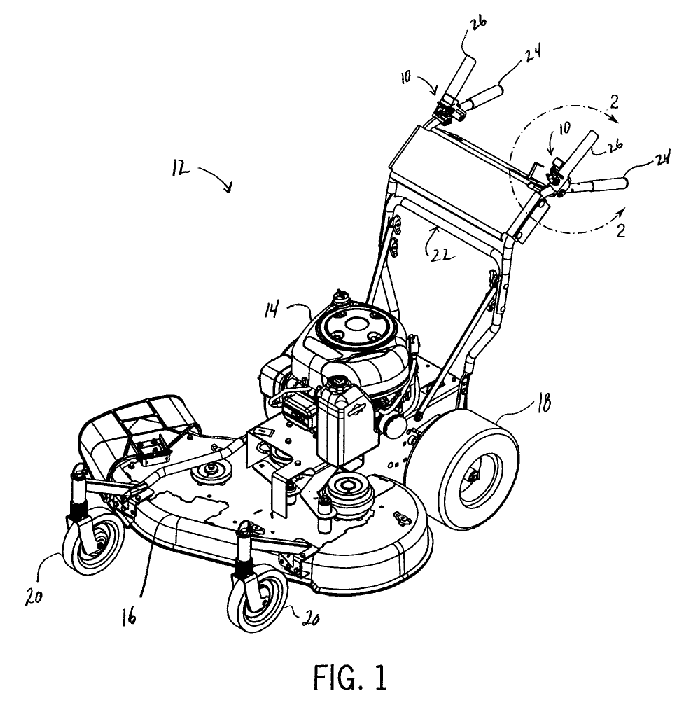

A mechanical interlock 10, in accordance with an example embodiment, is shown in FIG. 1. The mechanical interlock 10 is coupled to a lawnmower implement 12 generally used for mowing grass in a residential or commercial environment. The lawnmower implement 12 includes an engine 14 mounted to a deck 16. The engine 14 powers a pair of drive wheels 18 via a first clutch attached to a power take off (PTO) (not shown). A pair of swivelable steering wheels 20 extend forward of the deck 16. A pair of blades (not shown) are rotatably mounted under the deck 16 and are driven by a second clutch coupled to the PTO (not shown).

A handle assembly 22 extends rearward and upward from the deck 16 terminating in a pair of handles 24 that allow an operator to control the movement of the lawnmower implement 12. The example lawnmower implement 12 includes a pair of control paddles 26, one for engaging or actuating the first clutch coupled to the drive wheels 18, and another for activating the second clutch coupled to the blades. The general design and construction of the basic lawnmower implement 12, clutches, and PTO are known to those having ordinary skill in the art.

Each control paddle 26 incorporates a mechanical interlock 10 to prevent unintended engagement of the PTO; however, only one of the control paddles 26 will be used to describe the preferred construction and operation of the mechanical interlock 10, as the other operates and is constructed in substantially the same manner. It is further contemplated by the present invention that any number of control paddles 26 may be incorporated with the implement as desired. For example, a string trimmer may only require a single control paddle to activate the rotation of a spindle head from which the string extends to shear grass, shrubs, and the like.

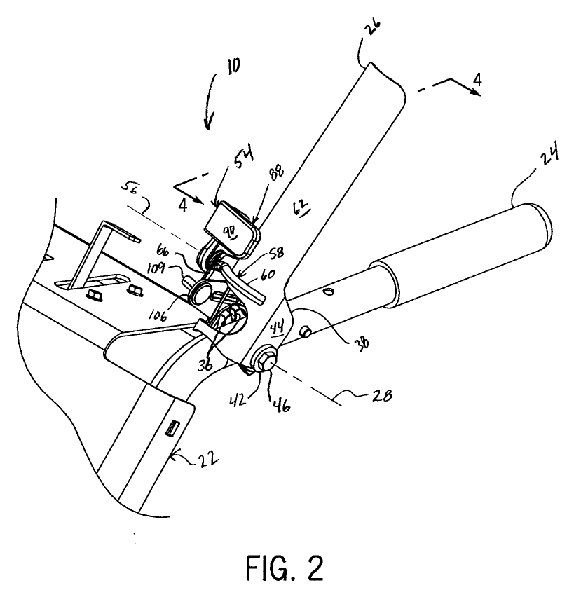

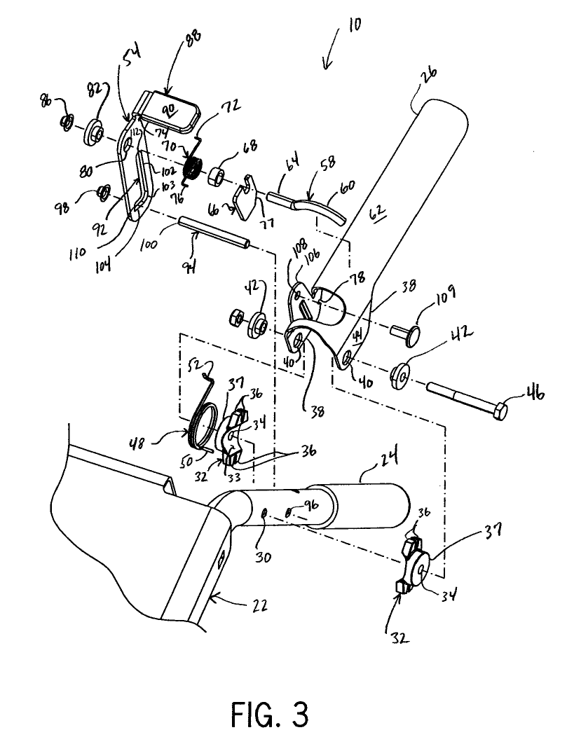

With additional reference to FIGS. 2 and 3, the control paddle 26 is pivotally coupled to the handle 24 to rotate with respect to the handle 24 about a control axis 28. In the example embodiment, the handle 24 has a pair of handle holes 30 formed essentially perpendicular to the central axis of the handle 24, thus defining the control axis 28. A pair of collar bushings 32 have an interior surface 33 contoured to match the radius of the handle 24 and are assembled to capture the handle 24 by aligning a collar hole 34 formed in each with the handle hole 30 formed in the handle 24. Alternatively, the control paddle 26 may be rotatably attached to the handle in a variety of other ways, such as by a blind rivet. Furthermore, the handle 24 need not be circular in cross-section but may be rectangular, octagonal, oval, or any other suitable form factor. Accordingly, the collar bushings 32 will be configured to ensure sufficient engagement between the collar bushings 32 and the handle 24.

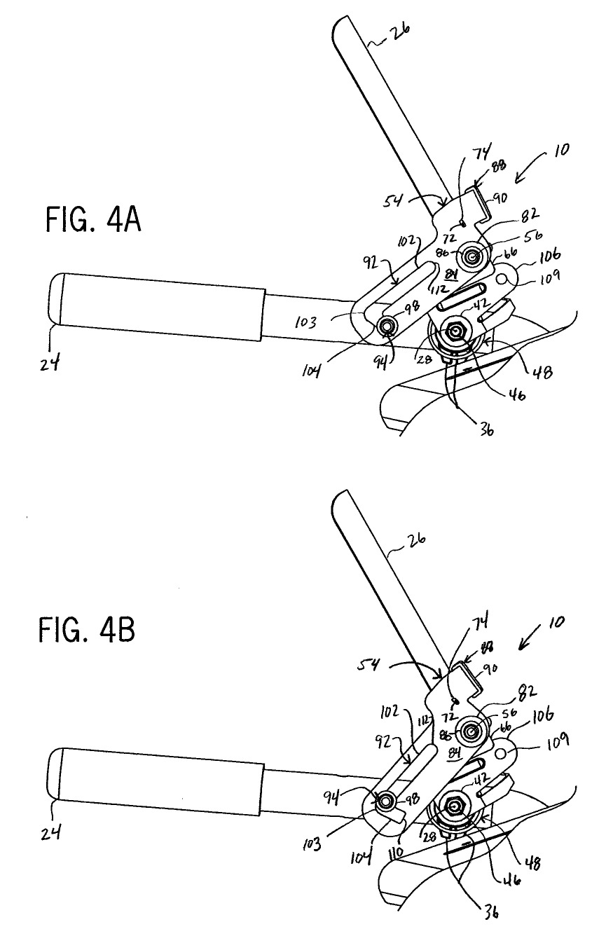

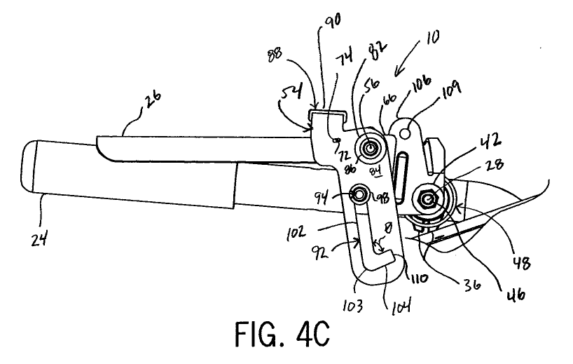

In the example embodiment, the control paddle 26 includes a pair of flanges 38, each having a coaxial control paddle hole 40. The flanges 38 are slid over a bearing portion 37 of the collar bushings 32 to align the control paddle holes 40 with the collar holes 34 and the handle holes 30 (best shown in FIG. 3). A pair of stepped, cylindrical bushings 42 are adjacent to the outer surface 44 of the flanges 38 and extend partially inwards through the control paddle holes 40. A biasing member, such as a control paddle torsion spring 48, is included between one of the flanges 38 and one of the collar bushings 32 to bias the control paddle 26 toward the open, deactivated position (shown in FIG. 2 and FIG. 4A). The torsion spring 48 includes a first index tab 50 seated between forks 36 extending from the collar bushing 32 and a second index tab 52 seated in a notch 78 formed in a flange 38 (note that the first index tab 50 and the second index tab 52 of the torsion spring 48 are shown in the unengaged state). Each collar bushing 32 includes a pair of opposing forks 36 to allow the collar bushings 32 to be interchangeable.

A fastener 46, such as a partially threaded cap screw and nut, is inserted along the control axis 28 through the bushings 42, control paddle holes 40, collar holes 34, handle holes 30, and torsion spring 48 to rotatably couple the control paddle 26 to the handle 24. As a result, the control paddle 26, while biased open (i.e., away from the handle 24), can rotate about the control axis 28 to activate and deactivate the PTO for the coupled working device (e.g., drive wheels 18, blades, auger, impeller, fan, and the like). The control paddle 26 further includes a tab 106 having a hole 108 formed therein. The hole 108 is sized to receive and secure a cable mount 109, such as a pin, that is linked to a cable (not shown) to energize and de-energize the corresponding PTO as is know to one of ordinary skill in the art. However, in order for the control paddle 26 to be activated or depressed, the mechanical interlock 10 must be unlocked, as discussed below.

The mechanical interlock 10 includes an interlock bracket 54 that is pivotally coupled to the control paddle 26 so as to be selectively rotatable about an interlock axis 56. The interlock bracket 54 rotates relative to the control paddle 26 and also moves with the control paddle 26 because it is coupled thereto. In the preferred embodiment described, the control axis 28 and the interlock axis 56 are not coaxial, however, the mechanical interlock 10 may be configured such that the control axis 28 and interlock axis 56 are the same axis.

The interlock bracket 54 is mounted to the control paddle 26 via a mounting rod 58 having a curved portion 60 secured, for example by welding, to the top surface 62 of the control paddle 26. A straight portion 64 of the mounting rod 58 is seated in a support plate 66 that is fixed (by any standard technique, such as welding) to a flange 38 of the control paddle 26. A spacer 68 and a torsion spring 70 (i.e., biasing member) are slid over the straight portion 64 of the mounting rod 58 and sandwiched between the interlock bracket 54 and the support plate 66. A first index tab 72 of the torsion spring 70 is seated in a slot 74 formed in the interlock bracket 54 and a second index tab 76 engages a bearing surface 77 of the support plate 66, resulting in the interlock bracket 54 being biased clockwise as viewed in FIG. 4A (again, it is of note that the first index tab 72 and the second index tab 76 of the torsion spring 70 are shown in FIG. 3 in the unengaged state). The interlock bracket 54 includes a mounting hole 80 that receives the straight portion 64 of the mounting rod 58. A stepped bearing 82 abuts the exterior surface 84 of the interlock bracket 54 and extends partially into the mounting hole 80. An end cap 86 is secured to the mounting rod 58 by internal barbs (not shown) to capture the interlock bracket 54 while allowing it to rotate about the interlock axis 56.

To initiate rotation of the mechanical interlock 10 about the interlock axis 56 and against the bias of the torsion spring 70, the interlock bracket 54 includes a bent over activation tab 88 covered by a grip 90. The rotation of the interlock bracket 54 is further constrained by a guide path 92 formed in the interlock bracket 54. In the example embodiment, the guide path 92 rides along a guide member 94 during activation of the interlock bracket 54 and the control paddle 26. The guide member 94 may extend from the handle 24 after passing through a pair of holes 96 formed through the handle 24, and may be secured via welding or any conventional technique. An end cap 98 is secured, again preferably by internal barbs (not shown), to an end 100 of the guide member 94 to bear against the exterior surface 84 of the interlock bracket 54. In the example embodiment, the guide member 94 is in the form of a pin that extends from the handle 24, however, the guide member 94 may be any suitable structure capable of engaging and riding along or within the adjacent guide path 92.

The guide path 92 is preferably a generally L-shaped path having an actuating segment 102 and a locking segment 104 forming an intersection 103. The relative alignment between the actuating segment 102 and the locking segment 104 at the intersection 103 defines a preferably acute angle θ (best shown in FIG. 4C). The acute angle θ helps ensure that the mechanical interlock 10 will prevent unwanted activation of the control paddle 26 and help ensure that the interlock bracket 54 is biased toward the locked position when the control paddle 26 is attempted to be actuated without first actuating the mechanical interlock 10. Additionally, the guide path 92 is preferably slightly wider than the guide member 94 to prevent binding and the need for the guide path 92 to be arcuate to accommodate the pivoting of the interlock bracket 54 about the interlock axis 56 and the control axis 28.

The guide path 92 is preferably sized to allow full actuation of the control paddle 26, however, the actuating segment 102 may be sized to prohibit full actuation of the control paddle 26 to prevent, for example, an operator's fingers from being pinched between the control paddle 26 and the handle 24. Additionally, the guide path 92 may include multiple intersections 103 to establish a series of actuating segments 102 and locking segments 104, forming a stepped guide path 92 defining intermediate locked positions.

In the example embodiment, the guide path 92 is machined from the interlock bracket 54 to create the profile shown most clearly in FIGS. 4A-4C. Alternatively, the guide path 92 may take the form of a recess, channel, cavity, and the like, that is capable of capturing and directing the guide member 94. For example, while the cutout guide path 92 shown may be preferable, a three-sided guide path 92 defined by a channel formed into the interlock bracket 54 may have use in applications where it is desirable to prevent foreign objects (e.g., grass, twigs, etc.) from entering the guide path 92 and obstructing the engagement between the guide path 92 and the guide member 94. Many other variations are contemplated and are within the scope of the present invention.

One skilled in the art will appreciate the numerous variations for constructing and mounting the mechanical interlock 10. For example, in coupling the interlock bracket 54 to the control paddle 26, the mounting rod 58 may comprise a post welded to the control paddle 26, thereby eliminating the use of the support plate 66.

The components of the mechanical interlock 10, are preferably made of typical metallic, plastic, and composite materials. For example, the interlock bracket 54 may be easily produced from low carbon steel; alternatively, the interlock bracket 54 may be produced from acrylonitrile butadiene styrene (commonly referred to as ABS), fiberglass, and the like. Many variations and alterations will be appreciated by one skilled in the art.

The mechanical interlock 10 is generally moveable between three positions, namely a locked position, an engaged position, and an actuated position. With initial reference to FIG. 4A, the mechanical interlock is shown in the locked position. In this position, force applied to pivot the control paddle 26 toward the handle 24 will drive the distal end 110 of the locking segment 104 of the interlock bracket 54 into the guide member 94. The slightly acute intersection 103 ensures that the guide member 94 is directed toward the distal end 110 of the locking segment 104 and prevents actuation of the control paddle 26.

In order to pivot the control paddle 26, an operator must first apply force to the activation tab 88 to pivot the interlock bracket 54 about the interlock axis 56 to the engaged position shown in FIG. 4B. With the guide member 94 located at the intersection 103, the interlock bracket 54, and thus the control paddle 26, can be pivoted substantially in unison about the control axis 28. Continuing to depress the control paddle 26 toward the handle 24 results in the actuated position shown in FIG. 4C with the guide member 94 adjacent the actuation stop surface 112 of the actuating segment 102.

Releasing or deactivating the control paddle 26 results in the torsion spring 48 acting on the control paddle 26 to bias the control paddle 26 upwards to the de-energized position shown best in FIG. 4B. At the same time, the torsion spring 70 acting on the interlock bracket 54 biases the guide path 92 clockwise against the guide member 94 such that once the guide member 94 is positioned proximate the intersection 103, the interlock bracket 54 pivots to the locked position shown best in FIG. 4A. The mechanical interlock 10 is thus automatically reset to the locked position after the control paddle 26 is released.

The mechanical interlock 10 requires that the operator engage both the mechanical interlock 10 and the control paddle 26 to engage the PTO and the coupled working device. As a result, the mechanical interlock 10 reduces the operator's ability to involuntarily engage the PTO, and therefore creates an elegant, efficient system that minimizes inadvertent operation of the associated implement, while also reducing the occurrence of damage to the implement and working device.

While there has been shown and described what is at present considered the preferred embodiment of the invention, it will be obvious to those skilled in the art that various changes and modifications can be made therein without departing from the scope of the invention defined by the following claims. For example, where relative movement takes place between a moveable component and a stationary component, such as between the moveable guide path 92 and the stationary guide member 94, the dynamic characteristics of the components may be switched (i.e., the guide member 94 may be configured as moveable and the guide path 92 as stationary) and yet remain within the scope of the present invention.

I claim:

1. An implement, comprising:
a handle extending from the implement;
a control member pivotally coupled to the handle about a control axis; and
a mechanical interlock including:
an interlock bracket pivotally coupled to the control member about an interlock axis;
a guide path formed in the interlock bracket and having a locking segment and an actuating segment that define an intersection at an acute angle; and
a guide member coupled to the handle and configured to engage the guide path;
wherein the mechanical interlock is positionable at a locked position at which the guide member is proximate the locking segment, an engaged position at which the guide member is proximate the intersection, and an actuated position at which the guide member is proximate the actuating segment; and
wherein the control member is prevented from pivoting about the control axis when the mechanical interlock is in the locked position.

2. The implement of claim 1, further comprising a biasing member urging the mechanical interlock toward the locked position when the mechanical interlock is in the engaged position.

3. The implement of claim 1, wherein the control axis and the interlock axis are coaxial.

4. The implement of claim 1, further comprising a tab extending from the interlock bracket.

5. The implement of claim 1, wherein the control member is a control paddle operationally coupled to a working device.

6. The implement of claim 1, further comprising a pair of collar bushings spaced apart and positioned between the handle and the control member.

7. The implement of claim 1, wherein the guide member is a pin extending from the handle.

8. The implement of claim 1, further comprising a mounting rod coupled to the control member defining the control axis.

9. The implement of claim 1, wherein the guide member extends through the guide path.

10. The implement of claim 1, further comprising:
a deck supporting the handle;
a blade rotatably housed adjacent the deck;
an internal combustion engine supported by the deck and having a power take off; and
a clutch coupled to the power take off and the blade;
wherein when the mechanical interlock is in the engaged position, rotation of the control member engages the clutch to couple the power take off and the blade, and moves the mechanical interlock to the actuated position.

11. A mechanical interlock coupleable to a control member that is pivotally coupled to a handle about a control axis, comprising:
an interlock bracket defining a guide path having a locking segment and an actuating segment that form an intersection at an acute angle; and
a guide member configured to engage the guide path;
wherein one of the interlock bracket and the guide member is pivotally coupled to the control member about an interlock axis and the other of the interlock bracket and the guide member is coupled to the handle;
wherein the guide path and the guide member are selectively positionable between a locked position at which the guide member is proximate the locking segment, an engaged position at which the guide member is proximate the intersection, and an actuated position at which the guide member is proximate the actuating segment; and
wherein the control member is prevented from pivoting about the control axis when the guide path and the guide member are positioned at the locked position.

12. The mechanical interlock of claim 11, wherein the control member is pivotable about the control axis when the guide path and the guide member are positioned at the engaged position.

13. The mechanical interlock of claim 11, further comprising a biasing member urging the guide path and guide member toward the locked position when the guide path and guide member are positioned at the engaged position.

14. The mechanical interlock of claim 11, wherein the control axis and the interlock axis are coaxial.

15. The mechanical interlock of claim 11, wherein the control member is a control paddle operationally coupled to a working device.

16. The mechanical interlock of claim 11, further comprising:
a deck supporting the handle;
a blade rotatably housed adjacent the deck;
an internal combustion engine supported by the deck and having a power take off; and
a clutch coupled to the power take off and the blade;
wherein when the guide path and guide member are in the engaged position, rotation of the control member engages the clutch to couple the power take off and the blade, and moves the guide path and guide member to the actuated position.

17. A method of activating a control member that is pivotally coupled to a control handle about a control axis and incorporates a mechanical interlock, comprising the steps of:
providing an interlock bracket defining a guide path having a locking segment and an actuating segment that form an intersection at an acute angle;
providing a guide member configured to selectively engage the guide path;
pivoting one of the interlock bracket and the guide member about an interlock axis from a locked position at which the guide member is proximate the locking segment to an engaged position at which the guide member is proximate the intersection; and
pivoting the control member about the control axis to move the interlock bracket and the guide member from the engaged position to an actuated position at which the guide member is proximate the actuating segment.

18. The method of actuating the control member of claim 17, wherein the step of pivoting the control member about the control axis to move the interlock bracket and the guide member form the engaged position to the actuated position is prevented by the mechanical interlock until the one of the interlock bracket and the guide member that is pivotally coupled to the control member is pivoted about the interlock axis from the locked position to the engaged position.

19. The method of actuating the control member of claim 17, wherein the interlock bracket is pivotally coupled to the control member and the guide member is coupled to the control member.
